(19) United States
(12) Patent Application Publication
(10) Pub. No.: US 2025/0284822 A1
(43) Pub. Date: Sep. 11, 2025

(54) ASSESSMENT OF RAISED SECURITY EVENTS AT AN APPLICATION

(71) Applicant: Fortinet, Inc., Sunnyvale, CA (US)

(72) Inventors: Simon James Humphrey, Gerrards Cross (GB); Tobias Charles Bristow, Acton (GB)

(73) Assignee: Fortinet, Inc., Sunnyvale, CA (US)

(21) Appl. No.: 19/062,490

(22) Filed: Feb. 25, 2025

(30) Foreign Application Priority Data
Mar. 5, 2024 (GB) 2403211.2

(51) Int. Cl. G06F 21/57

(52) U.S. Cl. CPC G06F 21/577; G06F 2221/033

(57) ABSTRACT

Systems and methods for assessment of raised security events at an application are provided. In one example, first and second policy assessment entities are executed by a computing device. The first policy assessment entity is operable in a runtime environment of an application running on the computing device and monitors activity of the application, assesses that activity against a first set of policies and, in response to a determination that such an assessment meets certain criteria, transmits an indication of that activity to the second policy assessment entity. The second policy assessment entity is operable independent of the application and receives an indication of activity from the first policy assessment entity, assesses that activity against a second set of policies and, in response to a determination that an assessment of that activity against the second set of policies meets certain, performs a security action.

### CROSS REFERENCE TO RELATED APPLICATIONS

This patent application is related to and, under 35 U.S.C. 119, claims the benefit of and priority to Great Britain Patent Application No. 2403211.2, entitled ASSESSMENT OF RAISED SECURITY EVENTS AT AN APPLICATION, filed Mar. 5, 2024, which is hereby incorporated by reference in its entirety for all purposes.

### FIELD

Various embodiments of the present disclosure relate to endpoint security, in particular to the assessment of activity at a computer against security policies.

### BACKGROUND

Organizations implementing networks of computing devices may have cyber security solutions in place, including firewalls, network security appliances and antivirus solutions. However, such measures cannot necessarily manage insider risks. Intentional, or unintentional but damaging, actions by users of computing devices in a network can be a serious vulnerability to organizations that traditional tools may not be able to defend against.

Common identity management (CIM) tools cannot necessarily prevent a malicious insider with credentials from performing damaging actions, as they lack certain context. For example, sensitive data can be hosted on servers with access control rules, but they cannot quantify how it is affected by users' poor cyber hygiene practices. They also generally cannot track the effectiveness of their security controls and training.

Rules defined in security policies that are implemented by entities in a network can be an efficient way to detect real-world insider risk scenarios. For example, policies may be defined so as to permit the detection of users performing actions such as using restricted administrative tools, sending sensitive information outside of the organization, circumventing security restrictions or suspiciously printing documents during unusual hours.

When such activities by users are detected at a local device, a security event can be raised which can be reported from the local device to a remote monitoring entity, and/or action can be taken to block the operation of applications on which suspicious behavior has been detected.

Raised security events are typically assessed against security policies at an agent running on a computer. However, if the agent has been maliciously removed from the computer, or otherwise disabled, it may not be possible to detect suspicious events and take the appropriate action.

It is desirable to develop an approach that can overcome such issues.

### SUMMARY

Systems and methods are described for assessment of raised security events at an application. According to one embodiment, a first policy assessment entity and a second policy assessment entity are executed by a computing device. The first policy assessment entity is operable in a runtime environment of an application running on the computing device. The second policy assessment entity is operable independent of the application. The first policy assessment entity is configured to monitor activity of the application, assess that activity against a first set of one or more policies and, in response to a determination that such an assessment meets one or more criteria, transmit an indication of that activity to the second policy assessment entity. The second policy assessment entity is configured to receive an indication of activity from the first policy assessment entity, assess that activity against a second set of one or more policies and, in response to a determination that an assessment of that activity against the second set of one or more policies meets one or more criteria, perform a security action.

### BRIEF DESCRIPTION OF THE FIGURES

Embodiments of the present disclosure will now be described by way of example with reference to the accompanying drawings.

In the drawings:

FIG. 1 schematically illustrates a network of computing devices in accordance with an embodiment of the present disclosure.

FIG. 2 shows an example of implementation where a computer is configured to implement a first policy assessment entity and a second policy assessment entity in accordance with an embodiment of the present disclosure.

FIG. 3 shows an example of a method for implementation at a computing device in accordance with an embodiment of the present disclosure.

### DETAILED DESCRIPTION

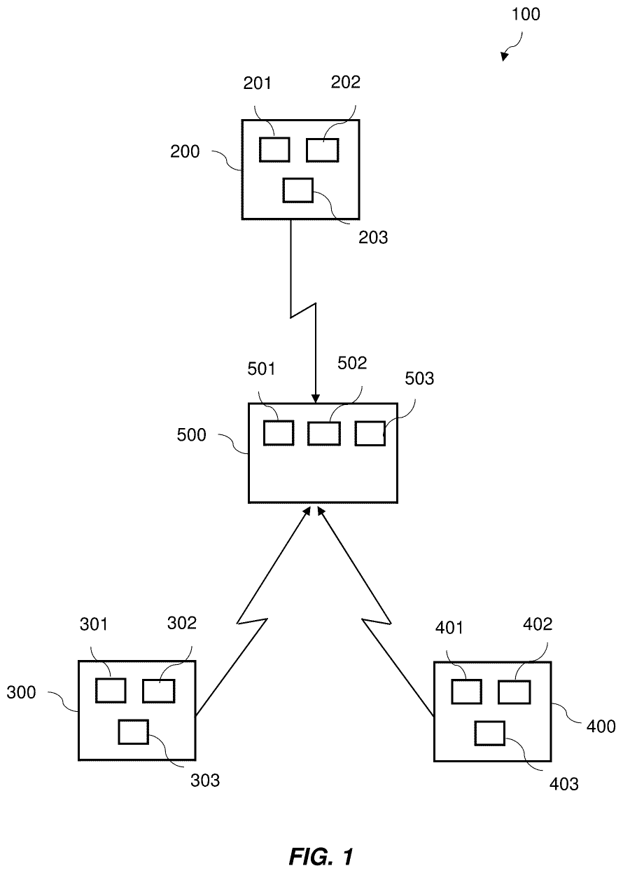

FIG. 1 schematically illustrates a network 100 comprising multiple data processing systems. In this example, the data processing systems are computing devices 200, 300, 400. Each computing device may be, for example, a desktop computer, laptop computer, tablet, mobile phone and/or server computer or a combination thereof. Other suitable computing devices may also be implemented in such a network. The devices may be connected in the network by wired and/or wireless connections. The network may, for example, be a corporate network. Access to the network may be restricted, for example by security devices that filter traffic at the boundary of the network. The network may interface via such security devices to a publicly accessible network such as the internet.

Computing devices 200, 300, 400 each comprise a processor 201, 301, 401 and a memory 202, 302, 402. The processor 201, 301, 401 may be implemented as dedicated hardware. Alternatively, the processor 201, 301 401 may be implemented as a computer program running on a programmable device such as a central processing unit (CPU). The respective memory 202, 302, 402 is arranged to communicate with the respective processor 201, 301, 401. Memory 202, 302, 402 may be a non-volatile memory. Each device 200, 300, 400 may comprise more than one processor and more than one memory. The memory may store data (i.e. the memory is a data carrier) that is executable by the processor. By executing program code contained in such data, the one or more processors may perform functions as described herein. The memory may store such program code in a non-transitory manner. The processor may be configured to operate in accordance with a computer program stored in non-transitory form on a machine-readable storage medium. The computer program may store instructions for causing the processor to perform its methods in the manner described herein.

Each computing device 200, 300, 400 can support a local software entity or agent. The software entity is able to collect information relating to the computing device and/or a user thereof. There may be one or more users authenticated to the computing device 200. The computing device supports the agent by storing and executing program code which, when executed, implements the agent. In this example the agent is a software entity. The agent may be implemented by one or more principal processors of the computing device, which processor(s) also implement functions of the computing device that implement the computing device's core functions. For example, if the computing device is a desktop computer, its core functions may include sending and receiving email and performing word processing tasks. Thus the principal processors may divide their time between implementing the agent and implementing other functions. Alternatively a dedicated processor may implement the agent.

The agent may be implemented as a user space application program. As used herein, user space applications are applications running in the user space, which is the memory area and a hardware privilege level of a data processing system where, for example, application software and some drivers may execute. The user space may be a limited part of the total memory of the data processing system (e.g. computing device). A user space application may have a corresponding user interface (UI) whereby a user can interact with the application. For example, the user may provide input to the application via the UI. In contrast to user space, kernel space (or supervisor mode) is memory area and hardware privilege level of the data processing system reserved for running an operating system kernel.

In addition to implementing the agent, the computing device may also implement other user space applications. The computing device may implement one or more user space applications that are not the agent.

Each device 200, 300, 400 may also comprise a transceiver 203, 303, 403 which allows the respective device to communicate with a remote monitoring entity at the central infrastructure apparatus 500.

Central infrastructure apparatus 500 also comprises a processor 501, a memory 502 and a transceiver 503. Processor 501 and memory 502 may operate as described above with reference to processor 201 and memory 202. The apparatus 500 may comprise more than one processor and more than one memory. Transceiver 503 may send or receive data to or from the transceivers 203, 303, 403 of any of the computing devices 200, 300, 400 in the network. The apparatus 500 may be communicatively coupled to a user interface which can, for example, allow a user of the apparatus 500 to specify particular settings relating to the security of files.

Each computing device 200, 300, 400 may receive information, such as security policies, from the apparatus 500. Each computing device 200, 300, 400 may also receive updates to the software entity that implements the agent from the central infrastructure apparatus 500. Each computing device 200, 300, 400 may also send information to the apparatus 500.

The computing devices 200, 300, 400 may implement different operating systems. For example, each computing device may implement one of the macOS, Windows or Linux operating systems.

Taking computing device 200 as example, computing device 200 implements a software entity in the form of an agent which monitors the computing device. The computing device 200 may implement a version of the agent suitable for the operating system running on the device 200. The agent, which acts as the local monitoring entity, monitors the device 200. The agent may monitor the operating system kernel on the device, and/or monitor the activity of applications running on the device, such as web browsers and email clients.

The local monitoring agent is configured to determine whether to raise a security event in dependence on one or more security policies. Policies are configurable rules that can be used to raise sensors/alerts based on activity detected by the local monitoring entity (agent). The policies preferably comprise a specification of actions on a computing device supporting a local monitoring entity that that local monitoring entity should report to a remote monitoring entity. Policies may specify actions such as the use of restricted administrative tools, sending sensitive information outside of the organization, circumventing security, accessing files, downloading data onto a USB device, and printing documents during irregular hours. Events may therefore be detected based on security policies comprising a specification of actions on the data processing system that the local monitoring entity is to report to a remote monitoring entity. Policies may also specify one or more particular attributes of a file, for example, file content or a part thereof, properties or characteristics of the file (such as file type, file name etc.), or metadata associated with the file.

The policies may specify one or more actions. If the one or more actions are detected by the agent to have occurred at the device (i.e. if activity at the device meets one or more criteria specified by one or more policies), the agent can raise an event. The policies may be stored at the device 200. Activity of the device may be assessed against a set of one or more security policies and an event may be raised if the assessment meets one or more criteria. The criteria may be predefined criteria. For example, an event may be raised when a user performs an action for the first time, and/or performs an action outside of normal working hours. In some examples, the criteria may define an event. In other implementations, the criteria may be defined by parameters of a model, such as a machine learning or statistical model. The agent may raise an event when the output of the model, based on input to the model associated with activity at the device 200, indicates that an event should be raised. The model may be received from the central infrastructure apparatus 500. The model may be stored at the memory 202 of the device 200 and be accessible by the processor 201. The processor 201 may execute the model.

If one or more of the actions defined in one or more of the policies are detected as having occurred, the local monitoring entity can raise an event. Raised events can be reported to a remote monitoring entity. The remote monitoring entity may be implemented at the central infrastructure 500. The raising of the event indicates that the violation of a security policy has occurred. In response, the remote monitoring entity may raise an alert and/or log the violation, optionally along with the user identifier of the user that violated the policy. In response to an event being raised, the device 200 or the infrastructure 500 may generate a visible and/or audible alert, and/or may store data relating to the policy violation. This stored data can be accessed by a user, such as an administrator.

To assess activity at the device against a set of one or more policies, the agent implements a policy assessment entity. In response to a determination that such as assessment meets one or more criteria, the policy assessment entity may cause the agent to perform a security action. For example, a security action may comprise one or more of storing a log of an event, reporting the activity to an entity external to the computer and causing operation of an application running on the computing device to be altered or blocked.

The policies may be received from another device, such as the central infrastructure apparatus 500. Updates to these policies may be made as appropriate.

As mentioned above, once events have been raised, they can be reported to an external entity such as a remote monitoring entity, for example at central infrastructure 500. This may be performed by sending the events from the local device to the external entity via a network, such as the internet.

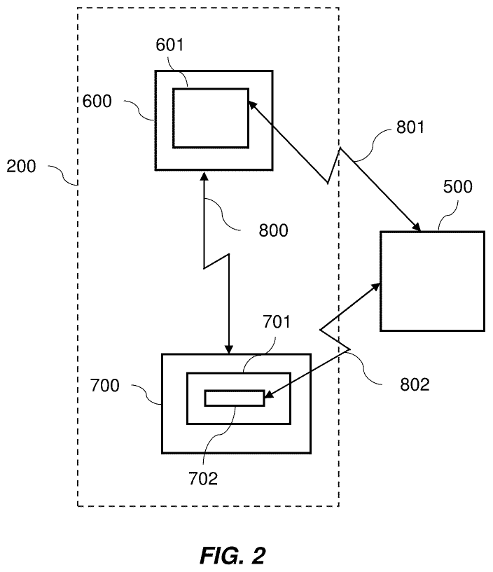

FIG. 2 schematically illustrates some further operational features of the computing device 200. As mentioned above, the device 200 may be configured to implement an agent, schematically illustrated at 600. The agent may operate as described above. The agent may implement application-level binaries and kernel/driver software.

The device 200 is also configured to implement an application. The application may be a user space application. In this example, the application in the form of a web browser, schematically illustrated at 700. However, the application may have other forms. For example, the application may be a messaging application that allows file sharing. Where the application is a web browser, the web browser may be, for example, Google Chrome, Mozilla Firefox, Apple Safari, Opera, Microsoft Internet Explorer or Microsoft Edge. The browser may be capable of implementing one or more browser extensions.

The agent 600 and the browser 700 may have between them a communication channel 800. The communication channel 800 may allow the agent and the application to bidirectionally exchange information.

The agent 600 has a module within the application level binary which is a policy assessment entity 601, which may be referred to as a policy engine. The agent 600 monitors activity on the machine it is running on, and all activity events (file open, application open, TCP connection made etc.) are run into the policy assessment entity 601. The activity is then run against a set of policy rules which look for particular things (e.g. TCP IP=“127.0.0.1”, application=“example.exe”) and if a rule is matched (which may be referred to as a detection), the event is reported to the infrastructure apparatus 500. The policy assessment entity 601 is operable in a runtime environment of an operating system of the computer 200.

The browser 700 implements a browser extension 701. Browser events (for example, websites visited, redirects, uploaded files, downloaded files, text copied into input fields, etc.) can also be fed from the browser extension 701 back into the agent along the communication channel 800, and into the policy assessment entity 601 at the agent 600.

The policy assessment entity 601 from the agent, or a part thereof, can be recompiled into a format which can run in the browser extension 701 (for example, using WASM see https://webassembly.org/) and the browser extension 701 can then run a separate policy assessment entity 702. The policy assessment entity 702 may assess browser events. The policy assessment entity 702 may run one or more policies that are different to policies run by the policy assessment entity 601.

This means that there are multiple (in this case, two) entities at the computer where policy rules can be checked; in the policy assessment entity 601 in the agent application, and in the policy assessment entity 702 which is running in the application (in this case, in the browser extension). The policy assessment entities may be software entities. A set of policy rules can be defined by an administrator. That set of rules can be transmitted to the policy assessment entity 601. The policy assessment 601 can analyze the set of policy rules and determine a subset of those rules that can be implemented by the policy assessment entity 702. The policy assessment entity 601 can transmit the subset of the rules to the policy assessment entity 702. The policy assessment entity 702 can be configured so as to automatically implement rules provided to it by the policy assessment entity 601. The policy assessment entity 601 can implement the remaining rules provided to it that are not in the subset. In this way, the policy assessment entity 601 can divide the rules mandated by the administrator for implementation by the entities 601, 702. If the entity 702 were not present then the administrator could provide the same rules to entity 601 and it might implement them all.

Herein, the policy assessment entity at the application is referred to as the first policy assessment entity and the policy assessment entity operable by the computer as an executable independently of the application is referred to as the second policy assessment entity.

The application and the first policy assessment entity are configured so that the application can run the first policy assessment entity in the execution environment of the application. The application is configured to run the first policy assessment entity in the execution environment of the application. The second policy assessment entity operates in a different execution environment from the application. The second policy assessment entity may operate in its own execution environment. An execution environment may refer to the environment defined by an operating system for a block of executable code to run in. It may comprise a set of constraints/permissions imposed by the operating system on a specific application running on the computer. Those constraints may include restrictions on accessing areas of memory associated with other execution environments.

The first and second policy assessment entities may both communicate with an entity external to the computing device 200, such as central infrastructure apparatus 500. The communication links between the policy assessment entity 601 at the agent and the policy assessment entity 702 at the browser and the remote entity 500 are shown at 801 and 802 respectively. The central infrastructure apparatus 500 may in some implementations be located at a cloud service.

The policy assessment entity 702, at the browser, may be operable in a runtime environment of the web browser. The policy assessment entity 601, at the agent, may be operable in a runtime environment of an operating system of the computer.

The policy assessment entity 702 can be defined in a language that allows the policy assessment entity to be complied at the application. This may be done by compiling the policy assessment entity that is running at the agent in a particular programming language (i.e. the second policy assessment entity) in a different programming language for execution at the application. In one implementation, the first policy assessment entity may be compiled in WASM (see https://webassembly.org/). Other languages may be used. Conveniently the first policy assessment entity is provided to the computing device that is to run it in pre-compiled form. This can make it more efficient to run, which can provide an especially substantial benefit in the case of security policies since they may be required to run in the background during any normal tasks so as to monitor operation of the system.

The application allows a compilation target to be executed within it. The compilation target is the first policy assessment entity, and the compilation source is the second policy assessment entity. This can allow a policy assessment component that is traditionally run at the agent to be run in the application, such as a web browser.

The first policy assessment entity has access to a first set of policies. The second policy assessment entity has access to a second set of policies. The first and second set of policies may have at least one common policy, or they may comprise different policies. In some implementations, the second policy assessment entity can be provided with data defining the first and second sets of policies. The second policy assessment entity may be configured to, on receiving the first set of policies, automatically provide the first set of policies to the first policy assessment entity.

The agent could send new policies over the communication channel 800 into the policy assessment entity at the browser. Alternatively, the browser extension could check with the infrastructure 500 for new policies and update the set of policies running in the browser extension.

In some implementations, the second policy assessment entity can be instructed to store first credentials for authenticating communication with the entity external to the computer (for example, infrastructure apparatus 500). The second policy assessment entity can form, in dependence on the first credentials, a second set of credentials for authenticating communication with the entity external to the computer and automatically provide the second credentials the first policy assessment entity. The first credentials may be different from the second credentials. This may allow the first policy assessment entity at the application to authenticate directly with the external entity, which can allow the reporting of raised events directly to the external entity (i.e. not via the agent) in some circumstances. This may be desirable where, for example, the agent has been disabled and cannot report raised events to the external entity.

Using this approach, events collected by the policy assessment entity at the application (for example, at the browser extension) do not need to be sent over communication channel 800 back to the main agent to run in the agent's policy assessment entity. That is, browser events can be more quickly checked within the policy assessment entity at the browser. Furthermore, in the event that the agent application is maliciously killed or crashes, the browser extension policy assessment entity is still active, so browser events would still be checked against configured policies. Events can be reported to the entity external to the computer (for example, central infrastructure apparatus 500) via a communication link 802.

In some implementations, a hybrid model may be used where certain “fast path” rules for browser events are first matched in the policy assessment entity at the application, and they are only sent to the policy assessment entity at the agent if needed. For example, if a rule in the policy assessment entity at the agent needs combinations of browser events and other machine events that the agent application has collected. If the event raised at the browser does not match one of the policies when evaluated at the first policy assessment entity, then the first policy assessment entity may not notify the second policy assessment entity.

In some implementations, policies in the policy assessment entity at the agent or the application could check for ‘heartbeat’ events being sent over the communications channel from the other of the agent or the application, and send an alert to an entity external to the computer (for example, to the central infrastructure apparatus) if it does not receive one. This may be indicative of the agent not running, having crashed or having been maliciously deactivated or removed. In this way, at least one of the policy assessment entities may be configured to repeatedly verify that the other policy assessment entity is operating on the computer and in response to that verification being negative, transmit an alert to an entity external to the computer.

To do this, at least one of the first and second policy assessment entities may be configured to periodically transmit a message to the other of the first and second policy assessment entities. That other of the first and second policy assessment entities may be configured to, in response to not receiving such a message for a predetermined period of time, form a negative verification of that one of the first and second policy assessment entities being operating on the computer. In response to the negative verification being negative, an alert may be transmitted to an entity external to the computer, such as infrastructure apparatus 500. This may allow the computer to determine that one or more of the first and second policy assessment entities are not operating.

The security action may comprise one or more of the following: transmitting an alert to an entity external to the computer (such as remote monitoring entity at infrastructure apparatus 500) storing a log of an event and blocking an activity of the application. For example, where the application is a web browser, the security action may comprise blocking operation of the browser. This may prevent a user from accessing website that could pose a security risk.

In some implementations, the second policy assessment entity is further configured to, in response to a determination that an assessment of that activity against the second set of one or more policies meets one or more criteria, transmit an indication of a predetermined form to the first policy assessment entity. In response to receiving an indication of a predetermined form from the second policy assessment entity, the first policy assessment entity can cause operation of the application to be altered or blocked. The indication of a predetermined form may in some cases be a message or a signal that informs the first policy assessment entity that it should cause operation of the application to be altered or blocked.

In some implementations, the policy assessment entity at the agent may be capable of determining whether one or more policies in its second set of policies are relevant to activity of the application, and if that determination is positive, it may cause those one or more policies to be included in the first set of policies at the application.

In some implementations, the first policy assessment entity may receive new policies from the second policy assessment entity at the agent and/or an entity external to the computer and include those policies in the first set of policies.

The computer 200 may also implement one or more further applications. The one or more further applications may also have a respective policy assessment entity for monitoring activity of the respective application, assessing that activity against a set of policies (which may be different to the policies run at the other policy assessment entities) and in response to a determination that such an assessment meets one or more criteria, transmit an indication of that activity to the policy assessment entity 601 at the agent.

For example, a further application on the computer may be a messaging application. The messaging application may allow file sharing between users if the application. A further policy assessment entity may be operable in a runtime environment of the further application. The further policy assessment entity may monitor activity of the further application. For example, activity involving file sharing between users of the messaging application. The further policy assessment entity may assess that activity against a third set of policies at the policy assessment entity running in a runtime environment at the further application. The third set of policies may be different to the first set of policies and/or the second set of policies. In response to a determination that such an assessment meets one or more criteria, the policy assessment entity at the further application may transmit an indication of that activity to the second policy assessment entity at the agent. That activity may then be assessed at the second policy assessment entity against the second set of policies. In response to a determination that an assessment of that activity against the second set of one or more policies meets one or more criteria, the second policy assessment entity may perform a security action. For example, in response to a determination that an assessment of that activity against the second set of one or more policies meets one or more criteria, the second policy assessment entity may transmit an indication of a predetermined form to the further policy assessment entity. In response to receiving an indication of a predetermined form from the second policy assessment entity, the further policy assessment entity may cause operation of the further application to be altered or blocked. This may allow activity at different applications to be monitored independently.

In some implementations, the computer may not implement an agent, or the agent may have been accidentally or intentionally deactivated. In this case, there will not be an operational policy assessment entity at the agent and there may be a policy assessment entity at one or more applications. Each policy assessment entity at an application is configured to monitor activity of the respective application and assess that activity against a respective set of one or more policies. In response to a determination that such an assessment meets one or more criteria, the policy assessment entity at the application may, for example, perform a security action, or transmit an indication of that activity to an entity external to the computer. This may allow the policy assessment entity at the application to, for example, block operation of the application and/or report raised events directly to a remote monitoring entity, for example at the central infrastructure apparatus.

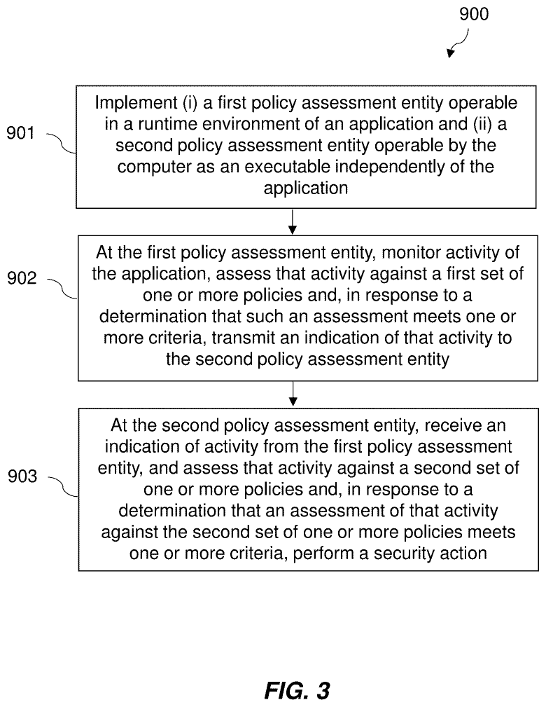

FIG. 3 shows the steps of an exemplary method 900 for monitoring activity at a computer that implements an application. At step 901, the method comprises implementing (i) a first policy assessment entity operable in a runtime environment of the application and (ii) a second policy assessment entity operable by the computer as an executable independently of the application. At step 902, the method comprises, at the first policy assessment entity, monitoring activity of the application, assessing that activity against a first set of one or more policies and, in response to a determination that such an assessment meets one or more criteria, transmitting an indication of that activity to the second policy assessment entity. At step 903, the method comprises, at the second policy assessment entity, receiving an indication of activity from the first policy assessment entity, and assessing that activity against a second set of one or more policies and, in response to a determination that an assessment of that activity against the second set of one or more policies meets one or more criteria (which may be the same as or at least partially different to the criteria above for the first set of policies), performing a security action.

The approach described herein may assist in preventing malicious activities from occurring by alerting on suspicious behavior and in response, the local computing devices may block activities at applications. This may improve cyber hygiene and keep data and endpoints secure, regardless of location (for example, whether the user is in the office or working remotely) and network connection (for example, public Wi-Fi or VPN). This may provide improved endpoint security, as well as visibility into user behavior, data access, and system use.

A communication channel between the agent and the browser extension may not be required, as the application can directly report detections to the infrastructure without going via the agent.

The computing device may implement an operating system such as Linux, Windows and MacOS. The policy assessment entity operating the browser extension may be configured to run on computing devices implementing operating systems that do not support the agent. This may advantageously allow security events associated with activity at the application to be detected on computing device that are not running an agent.

Furthermore, running an agent on the computing device can use more memory and/or more CPU resources. It can be beneficial from a memory and/or resource perspective to run the policy engine fully or partially at the application.

Additionally, the deployment of applications extensions such as browser extensions may be easier than deploying agents running on a computer, especially for large organizations. If an organization only requires application policies (such as browser policies) to run, then they can remove the need to deploy the agent application, which is generally more difficult and more CPU/memory intensive.

Conveniently, upgrades of the policy assessment entity at the browser may be implemented by installing a new browser extension, which the browser can handle the upgrades of. Upgrades of the policy assessment entity at the agent can be implemented by installing a new agent installation, and deploying this across potentially hundreds of thousands of machines across different operating systems may be difficult to manage. Therefore, it may be desirable to only update the policy assessment entity at the application, which may be more efficient.

The extension may run in applications other than web browsers. For example, it could run in document processing software or a communication client such as an email client. In those cases, the extension could implement policies that verify the integrity of documents or communications that are being stored, retrieved or processed by the application. The extension would run in the execution environment of the respective application.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the present disclosure.

What is claimed is:

1. A non-transitory machine-readable medium storing instructions, which when executed by one or more processors of a computing device, cause the computing device to:
execute a first policy assessment entity operable in a runtime environment of an application; and
execute a second policy assessment entity that is operable independent of the application;
wherein:
the first policy assessment entity is configured to monitor activity of the application, assess that activity against a first set of one or more policies and, in response to a determination that such an assessment meets one or more criteria, transmit an indication of that activity to the second policy assessment entity; and
the second policy assessment entity is configured to receive an indication of activity from the first policy assessment entity, assess that activity against a second set of one or more policies and, in response to a determination that an assessment of that activity against the second set of one or more policies meets one or more criteria, perform a security action.

2. The non-transitory machine-readable medium of claim 1, wherein the second policy assessment entity is further configured to, in response to a determination that an assessment of that activity against the second set of one or more policies meets one or more criteria, transmit an indication of a predetermined form to the first policy assessment entity.

3. The non-transitory machine-readable medium of claim 1, wherein the first policy assessment entity is further configured to, in response to receiving an indication of a predetermined form from the second policy assessment entity, cause operation of the application to be altered or blocked.

4. The non-transitory machine-readable medium of claim 1, wherein the security action comprises one or more of storing a log of an event, reporting the activity to an entity external to the computing device and causing operation of the application to be altered or blocked.

5. The non-transitory machine-readable medium of claim 1, wherein the first policy assessment is further configured to, in response to a determination that such an assessment of the activity of the application against the first set of policies meets one or more criteria, perform a further security action.

6. The non-transitory machine-readable medium of claim 5, wherein the further security action comprises logging the activity or reporting the activity to an entity external to the computing device.

7. The non-transitory machine-readable medium of claim 1, wherein the second policy assessment entity can be instructed to store first credentials for authenticating communication with an entity external to the computing device, and is configured to:
form, in dependence on the first credentials a second set of credentials for authenticating communication with the entity external to the computing device; and
automatically provide the second credentials the first policy assessment entity.

8. The non-transitory machine-readable medium of claim 7, wherein the first credentials are different from the second credentials.

9. The non-transitory machine-readable medium of claim 1, wherein the second policy assessment entity can be provided with data defining the first and second sets of policies, and is configured to, on receiving the first set of policies, automatically provide the first set of policies to the first policy assessment entity.

10. The non-transitory machine-readable medium of claim 1, wherein at least one of the first and second policy assessment entities is configured to periodically transmit a message to the other of the first and second policy assessment entities, and that other of the first and second policy assessment entities is configured to, in response to not receiving such a message for a predetermined period of time, form a negative verification of that one of the first and second policy assessment entities being operating on the computing device.

11. The non-transitory machine-readable medium of claim 1, wherein at least one of the first and second policy assessment entities is configured to repeatedly verify that the other of the first and second policy assessment entities is operating on the computing device and in response to that verification being negative, transmit an alert to an entity external to the computing device.

12. The non-transitory machine-readable medium of claim 11, wherein each of the first and second policy assessment entities is configured to repeatedly verify that the other of the first and second policy assessment entities is operating on the computing device and in response to that verification being negative, transmit an alert to an entity external to the computing device.

13. The non-transitory machine-readable medium of claim 1, wherein the application comprises a web browser.

14. The non-transitory machine-readable medium of claim 1, wherein the second policy assessment entity is operable in a runtime environment of an operating system of the computing device.

15. The non-transitory machine-readable medium of claim 1, wherein the first policy assessment entity is configured to receive new policies from one or both of the second policy assessment entity or an entity external to the computing device and include those policies in the first set of policies.

16. The non-transitory machine-readable medium of claim 1, wherein the application is capable of invoking one or more extensions and wherein the first policy assessment entity is operable as an application extension.

17. A method comprising:
executing, by a computing device, a first policy assessment entity operable in a runtime environment of an application running on the computing device; and
executing, by the computing device, a second policy assessment entity that is operable independent of the application;
wherein:
the first policy assessment entity is configured to monitor activity of the application, assess that activity against a first set of one or more policies and, in response to a determination that such an assessment meets one or more criteria, transmit an indication of that activity to the second policy assessment entity; and
the second policy assessment entity is configured to receive an indication of activity from the first policy assessment entity, assess that activity against a second set of one or more policies and, in response to a determination that an assessment of that activity against the second set of one or more policies meets one or more criteria, perform a security action.

18. The method of claim 17, wherein the application is capable of invoking one or more extensions and wherein the first policy assessment entity is operable as an application extension.

19. The method of claim 18, wherein the application comprises a web browser.

20. The method of claim 19, wherein the second policy assessment entity is operable in a runtime environment of an operating system of the computing device.
